(19) United States
(12) Patent Application Publication
(10) Pub. No.: US 2011/0168579 A1
(43) Pub. Date: Jul. 14, 2011

(54) SELF-ADHESIVE NOTEPAPER HOLDER

(75) Inventor: David C.T. JOUR, Taipei (TW)

(73) Assignee: Kudos Finder Trading Co., Ltd., Taipei (TW)

(21) Appl. No.: 12/687,856

(22) Filed: Jan. 14, 2010

(51) Int. Cl. B65D 85/00; B26F 3/02

(52) U.S. Cl. 206/215; 225/91

(57) ABSTRACT

The present invention provides a self-adhesive notepaper holder, which combines at least a notepaper of different patterns, one is rolling notepaper and the other is draw-off notepaper; the holder is composed of symmetrical left and right casings with a hollow egg shape, wherein butt-jointed sleeves are set for fixation of the rolling notepaper, and butt-jointed slots are also arranged for embedding of the draw-off notepaper; moreover, two parallel supporting bars are arranged on the circumference of the holder for stable standing; a rectangular opening is used for output of rolling notepaper, with one side connected with a curved arc and several sawtooth structures, allowing easy draw off and tear off of the rolling notepaper; and a long notch is used for drawing off single piece of notepaper; this design is suitable for the office work with its diversified functions such as: recording, messaging and labeling.

### BACKGROUND OF INVENTION

1. Field of the Invention

The present invention generally relates to a self-adhesive notepaper holder, and more particularly to an innovative one that permits the combination of multiple self-adhesive notepaper holders of different shapes so as to prevent the waste of space and utilize them more efficiently.

2. Description of Related Art

The self-adhesive notepaper for marking, labeling, recording and messaging purposes is generally available with writing, printing and labeling functions. Meanwhile, it can be adhered flexibly to the visible locations allowing for convenient real-time reminding of the users. Moreover, the self-adhesive notepaper can be fabricated into a structure of different dimensions and colors for more visible visual effect.

Generally, a self-adhesive notepaper is of a single notepaper structure or otherwise combined with an accommodating seat. Different types of notepaper are generally required for the office work; however, this may lead to disorderly placement of notepaper and decrement in work efficiency.

To overcome the aforementioned problems of the prior art, it would be an advancement if the art introduces an improved structure that can significantly improve the efficacy.

Therefore, the inventor has provided the present invention of practicability after deliberate design and evaluation based on years of experience in the production, development and design of related products.

### SUMMARY OF THE INVENTION

The primary objective of the present invention is to provide a self-adhesive notepaper holder, which could address the problems of conventional self-adhesive notepaper (e.g.: difficulty of drawing off and tearing off) through extremely simple and flexible operating modes; and a compact accommodating structure is combined to shape a self-adhesive notepaper holder enabling convenient draw off and tear off of the self-adhesive notepaper.

Based on the above, a self-adhesive notepaper holder is designed with a holder body that combines a rolling and a draw-off notepaper; of which the holder body is composed of two symmetrical casings with a hollow egg-shaped structure. The holder body contains: butt-jointed sleeve for setting of the rolling notepaper, and butt-jointed slot for embedding of draw-off notepaper; on the circumference of the holder body, the following parts are set: two parallel supporting bars for stable standing; a rectangular opening for output of the rolling notepaper, either side of which is connected with a curved arc and a sawtooth structure, allowing an easy draw off and tear off of the rolling notepaper; and a long notch for drawing off and output of the draw-off notepaper; with this combination, you're allowed to conduct the office work efficiently while recording, leaving messages and labeling very freely.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1: a perspective view of a preferred embodiment of the present invention.

FIG. 2: an assembly view of a preferred embodiment of the present invention.

FIG. 3: a combined view of a preferred embodiment of the present invention.

FIG. 4: a tear-off view of a preferred embodiment of the present invention.

FIG. 5: a draw-off view of a preferred embodiment of the present invention.

### DETAILED DESCRIPTION OF THE INVENTION

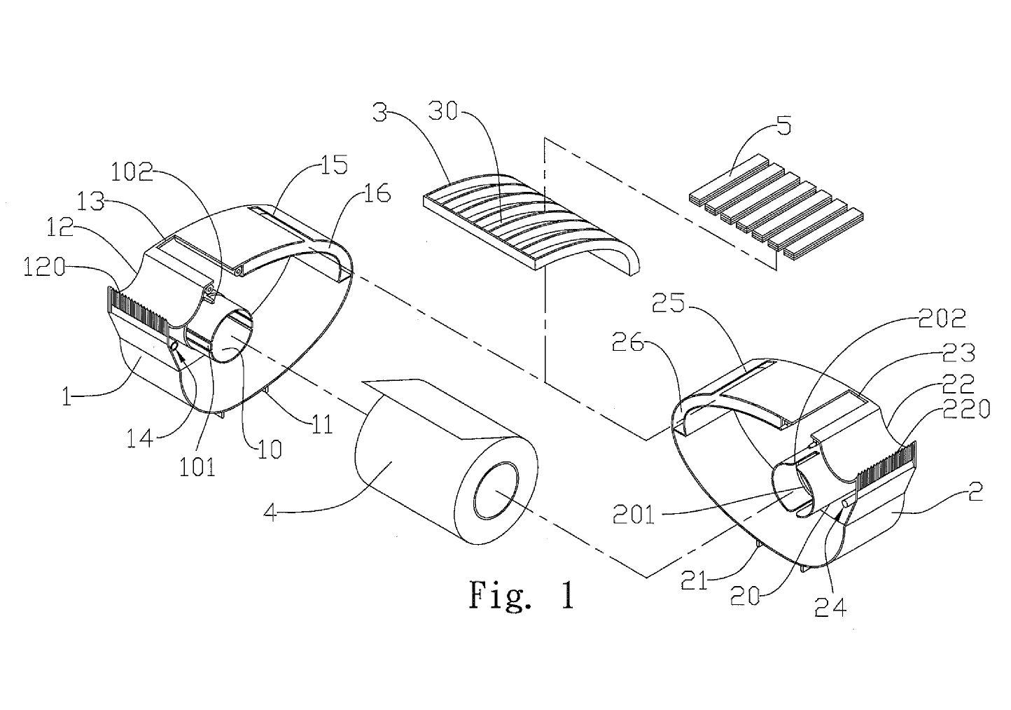

Referring to FIG. 1, the present invention discloses a self-adhesive notepaper holder, which comprises: a left casing 1, a right casing 2, a notepaper holder 3, a rolling notepaper 4 and a draw-off notepaper 5. The left casing 1 is of a hollow egg-shaped, onto its closed surface a columnar sleeve 10 is set inward; a stepped reducing flexible hook 101 is formed symmetrically at the free end of the sleeve 10, while a misaligned guiding coupling portion 102 is set symmetrically on the circumference at the stepped joints; in this preferred embodiment, flanged ribs are set symmetrically on the circumference; additionally, on the circumference of the left casing 1, the following parts are set: two parallel supporting bars 11 for stable standing; a curved arc 12, with one side connected with several sawtooth structures 120 for tear-off of the self-adhesive notepaper, and the other side connected with a rectangular opening 13; at least a coupling portion 14 is set onto the open side of the circumference of the left casing 1 in a very simple combined pattern; in this preferred embodiment, the openings of any aperture are combined; besides, an arched slot 16 is set within the circumference of the left casing 1, and then connected with a long notch 15 on the circumference.

The right casing 2 is also of a hollow egg-shaped, and aligned symmetrically with the left casing 1 to form a combined body, onto the closed surface of which a columnar sleeve 20 is set inward to be in contact with the sleeve 10 of the left casing 1; a stepped reducing ring flange 201 with a protruding end is formed at the free end of the sleeve, enabling secure locking of the aforementioned flexible hook 101; meanwhile, a guiding coupling portion 202 is set symmetrically on the circumference of the free end of the sleeve 10; in this preferred embodiment, the symmetrical groove can be mated securely with the aforementioned rib; in addition, on the circumference of the right casing 2, the following parts are set: two parallel supporting bars 21 for stable standing; a curved arc 22, with one side connected with several sawtooth structures 220 for tear-off of the self-adhesive notepaper, and the other side connected with a rectangular opening 23; at least a coupling portion 24 is set onto the circumference of the right casing 2, and aligned with the coupling portion 14 of the left casing 1; in this preferred embodiment, the bosses are combined; besides, an arched slot 26 is set within the circumference of the right casing 1, and then connected with a long notch 25 on the circumference.

The notepaper holder 3 of arched casing is provided with at least a space 30 arranged at interval; the notepaper holder 3 can be placed into the butt-jointed slots 16, 26 of the left casing 1 and right casing 2.

The rolling notepaper 4 is fitted into the butt-jointed sleeves 10, of the left casing 1 and right casing 2 for positioning and free rolling effect; one end of the rolling notepaper 4 is pulled out and then drawn off partially from the rectangular openings 13, 23, and then cut off by the sawtooth structures 120, 220 formed by the left casing 1 and right casing 2.

The draw-off notepaper 5 of a long sheet pattern is superimposed vertically and misaligned transversely, and can be placed into a space 30 within the notepaper holder 3; in this preferred embodiment, the notepaper holder 3 can accommodate 7 superimposed draw-off notepapers 5, and place them into the butt-jointed slots 16, 26 of the left casing 1 and right casing 2; moreover, the draw-off notepaper 5 is drawn out from long notches 15, 25 of the left casing 1 and right casing 2 for easy utilization by the user.

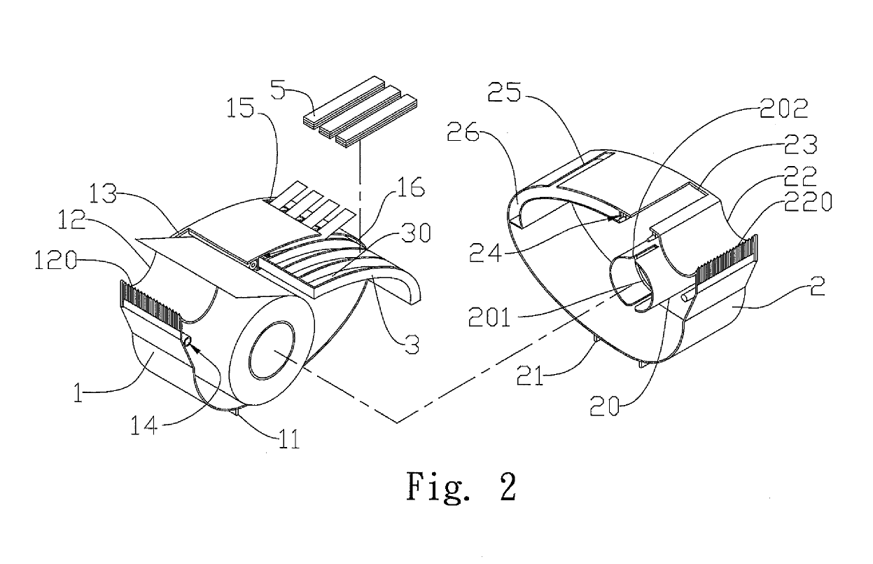

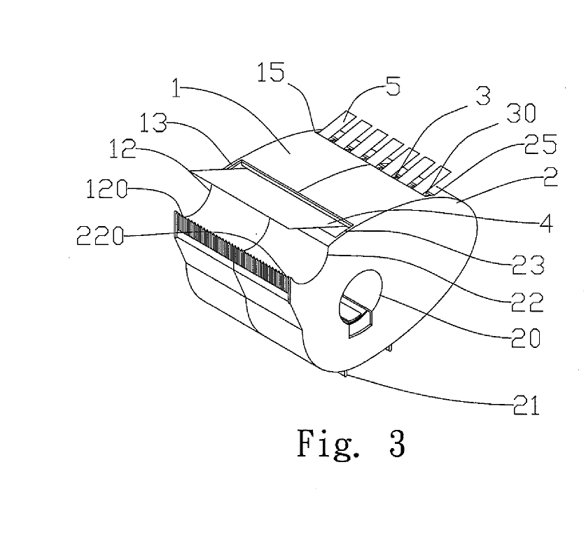

Referring to FIG. 2, the notepaper of different shapes can be placed into the holder; the rolling notepaper 4 is fitted into the sleeve 10 of the left casing 1 (or right casing), then drawn out partially from the rectangular opening 13; next, at least a draw-off notepaper 5 is filled into several spaces 30 of the notepaper holder 3, and fed into the slot 16 fixedly, and a single notepaper is pulled out of the long notch 15; after installation of the notepaper, the right casing 2 (or left casing) is overlapped, then the coupling portions 14, 24 are coupled through the butt-jointed sleeves 10, 20, and then interlocked securely with the ring flange 201 via the flexible hook 101 of two sleeves 10, 20; in addition, two symmetrical supporting bars 11, 21 are set on the circumference of the left casing 1 and right casing 2 to form equal-height contacts for the stable placement and standing of the holder, as shown in FIG. 3.

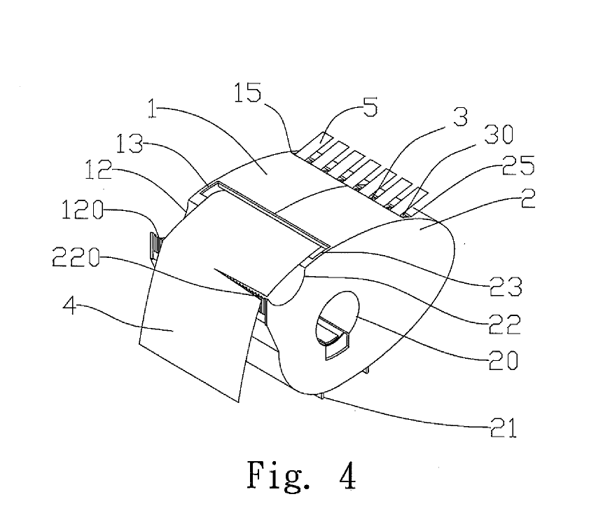

Referring also to FIG. 4—an application status view of the rolling notepaper in the preferred embodiment, where a finger is firstly put into the curved arcs 12, 22 of the holder, if necessary, to pull out the notepaper of required length, and then clip the notepaper by several connected sawtooth structures 120, 220 to obtain the intended notepaper while realizing free and convenient tear-off and utilization.

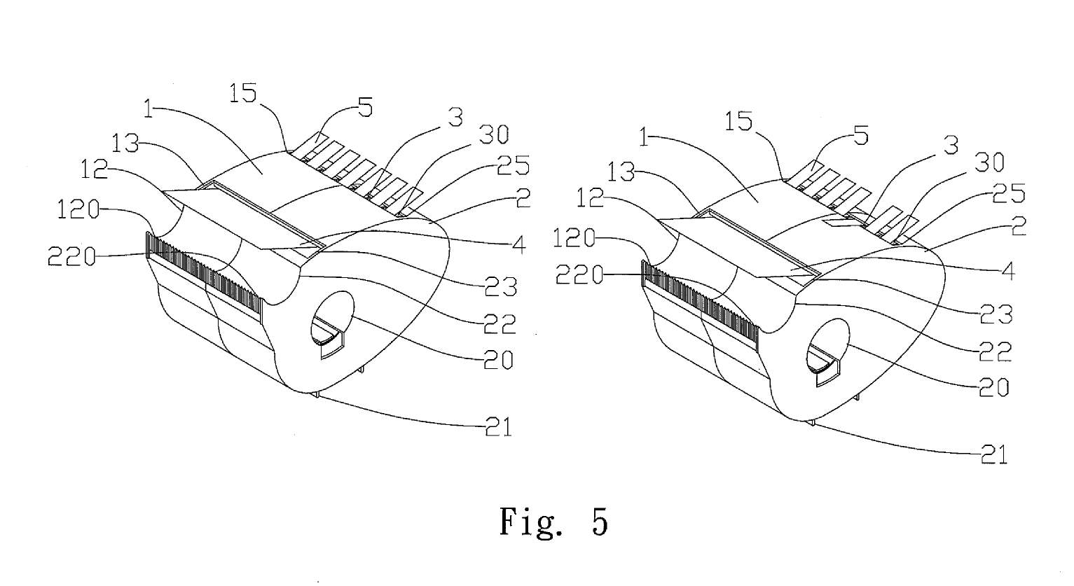

Referring also to FIG. 5—an application status view of the draw-off notepaper in the preferred embodiment, where every layer of draw-off notepaper 5 is superimposed vertically and misaligned transversely, so the notepaper can be drawn out continuously and conveniently once a piece of notepaper is pulled out; moreover, you can select and utilize freely the notepaper due to different color of every layer of draw-off notepaper 5.

On the whole, the “self-adhesive notepaper holder” of the present invention can address the problems of conventional self-adhesive notepaper such as: difficulty of drawing off and tearing off; and in combination with easy-to-operate structure, the self-adhesive notepaper can be drawn out and clipped more simply, or placed in a standing state. The patent claim is filed since the present invention has made breakthrough innovation in compliance with the spirit of patent application.

Although the invention has been explained in relation to its preferred embodiment, it is to be understood that many other possible modifications and variations can be made without departing from the spirit and scope of the invention as hereinafter claimed.

1. A self-adhesive notepaper holder, comprising:
a left casing of a hollow shape, onto its closed surface a sleeve is set inward, and a coupling portion is set on its circumference, into which a slot is provided;
a right casing, located symmetrically with the left casing to form an integrated body, onto its closed surface a sleeve is set inward, and a coupling portion is set on its circumference, into which a slot is provided;
a rolling notepaper, fitted into butt-jointed sleeves of left and right casings; and
a draw-off notepaper, placed into the slot formed by the left and right casings.

2. The self-adhesive notepaper holder as claimed in claim 1, wherein a holder is set within the slot formed by the left and right casings, and at least a space is arranged onto the holder.

3. The self-adhesive notepaper holder as claimed in claim 1, wherein a curved arc is set on the circumference of the left and right casings, with one end connected with several sawtooth structures.

4. The self-adhesive notepaper holder as claimed in claim 1, wherein an opening is set on the corresponding circumference of the left and right casings and connected with the slot within the circumference, so as to form a channel for supplying the draw-off notepaper.

5. The self-adhesive notepaper holder as claimed in claim 1, wherein an opening is set on the corresponding circumference of the left and right casings and connected with the slot within the circumference, so as to form a channel for supplying the rolling notepaper.

6. The self-adhesive notepaper holder as claimed in claim 1, wherein the butt-jointed sleeve flanges of left and right casings are separately fitted with a coupling portion, which is either of rib or groove.

7. The self-adhesive notepaper holder as claimed in claim 1, wherein two symmetrical supporting bars are arranged on the corresponding circumference of the left and right casings.
